(19) United States
(12) Patent Application Publication
(10) Pub. No.: US 2006/0010348 A1
(43) Pub. Date: Jan. 12, 2006

(54) Method and apparatus for capture and formalization of system requirements and their transformation to test instructions

(76) Inventors: Stefan Erik Bylund, Akersberga (SE); Stig Nils-Olof Franzen, Marsta (SE); Erik Magnus Hyllander, Huddinge (SE); Karl Svante Lidman, Stockholm (SE)

Correspondence Address: Jaczone AB;Svante Lidman, Isfjordsgatan 22B, 5 tr, Kista, 164 40, SE

(21) Appl. No.: 10/886,691

(22) Filed: Jul. 9, 2004

(51) Int. Cl. G06F 11/00

(52) U.S. Cl. 714/38

(57) ABSTRACT

A method for capturing requirements on a system and subsequently transforming the requirements into a test instruction for the system is disclosed. In a exemplary embodiment, a set of flows that captures the requirements of the system are created by repeatedly combining predefined templates of natural language text and populating them with information particular to the system and annotations to support identification of test data such as inputs to and outputs from the system. Based on the requirements specification a test instruction is prepared. This is done by first identifying points in the specified flow where input data must be provided or output data must be verified when testing an actual implementation of the specified system. By combining different specified flows and by giving the identified input and output data specific values a complete test instruction is created.

### CROSS REFERENCE TO RELATED APPLICATIONS

US Patent Documents

| | | | |
|---|---|---|---|
| 6,725,399 | April, 2004 | Bowman | 714/38 |

### OTHER REFERENCES

OMG Unified Modeling Language Specification 1.5, http://www.omg.org/docs/formal/03-03-01.pdf

### BACKGROUND OF THE INVENTION

1. Field of the Invention

The invention relates to a method and apparatus for preparing requirements specifications for systems and for transforming such specifications into testing instructions suited for verification of that the system complies with the specified requirements. In particular the invention is well suited for specifying requirements and test instructions for digital computer systems.

2. Description of Prior Art

The ever increasing use of computer software in various business, domestic, and industrial applications puts a focus on the need for concepts, methods, and tools to support the development of such software. Such concepts, tools, and methods are often characterized to support a discipline called software engineering. On a high level, the overall goal of software engineering is to support timely and cost efficient development of software with high quality. There are different aspects of quality where the perhaps two most important aspects are:
Is the functions provided by the system the right functionality, i.e., does it adequately meet the (business) requirements of the users of the system?
Does the system perform these functions in a manner that is free from faults?

A prerequisite for the first bullet above is that the requirements of the users of the system (technical systems or humans) are captured in a complete, clear, and understandable way. A prerequisite for the second bullet above is that there is a method for testing that the implementation of the system complies with the requirements.

In U.S. Pat. No 6,725,399, a high-level method, said to support verification of a systems compliance with specified requirements, is claimed. At best the method described in U.S. Pat. No 6,725,399 provides a conceptual framework for organizing a test organization. It does, however, not provide any detailed concrete method or apparatus for defining requirements, nor does it provide any detailed method or apparatus for transforming requirements into tests and consequently provides no direct support for ensuring that tests actually correspond to the requirements on the system.

One common approach for specifying requirements (for technical systems as well as organizations) is use-case modeling. A use-case model is a model of the system's intended functions and its environment, and serves as a contract between the customer and the developers. The use-case model consists of so called Actors and Use Cases and relationships between them. Actors represent the set of roles that the different users of the system and any external systems that the system interoperates with can be categorized into. Use cases represent the functionality that the system offers to its Actors. Each use case captures the system's acceptable behavior when interacting with a specific Actor. It considers the variations that the system must handle to effectively meet that user's needs. When modeling a business the use cases represents the business processes that the business must support, while Actors captures parties external to the business, e.g., customers, suppliers and so on.

When describing the behavior of an individual use-case you prepare a so called use-case specification, which captures the behavior of the use case as a set of flows that when combined in various ways reflect different paths through the use-case in which an individual user can utilize the use case. When use-case specifications are available they form one of the most important inputs for the preparation of test instructions.

Use-case specifications are today typically created as plain text documents in a standard Word processor such as Microsoft Word. The advantage of this approach is that no special tools are used and that the description (if prepared by a person with the right experience and skills) is clear while still being easy to read and access by non-technical readers. The disadvantage is that the quality of the description is heavily dependent on the person creating the description. I.e., it takes a considerable amount of experience and training to become a skilled use-case writer. Another disadvantage is that the lack of formality makes it impossible to detect errors, inconsistencies, and incompleteness in the descriptions. The lack of formality also severely limits the level of tool support that can be created to transform use-case specifications into test descriptions.

There are also specialized tools to support the process of creating use-case descriptions. These tools can be stand-alone (SteelTrace Catalyst) or appear as an integrated part of a Unified Modeling Language (UML) modeling product (Visual Architect). These tools offer the possibility to describe the behavior of each use case in a step by step fashion. While these tools offer a basic level of formalization it is still so that these tools provide no support for detecting errors, inconsistencies, and incompleteness. While some such tools claim support for creating test instructions the support is essentially limited to simply reformatting the existing descriptions adding very little real value when creating a complete set of test instructions covering all relevant combinations of flows in each use-case or identifying necessary test data.

### BRIEF SUMMARY OF THE INVENTION

The foregoing discussed drawbacks and deficiencies of the prior art are over come or alleviated by a method for capturing requirements on a system and subsequently transforming the requirements into a test instruction for the system.

In a preferred embodiment, a set of flows that captures the requirements of the system are created by repeatedly combining predefined templates of natural language text and populating them with information particular to the system. Also, at this time, annotations to support identification of test data such as inputs to and outputs from the system are added to the requirements specification.

Based on the requirements specification a test instruction is prepared. This is done by first identifying points in the specified flow where input data must be provided or output data must be verified when testing an actual implementation of the specified system. By combining different specified flows and by giving the identified input and output data specific values a complete test instruction is created.

### BRIEF DESCRIPTION OF DRAWINGS

FIG. 1 is a process flow diagram which illustrates a method for capturing requirements on a system and subsequently transforming them into a test instruction for the system.

### DETAILED DESCRIPTION OF THE INVENTION

Disclosed herein is a method which supports capturing requirements on various kinds of systems including software, hardware and business organizations seen as systems. The method results in an annotated natural language requirements specification, which is easy to read and understand for non-technical persons but which at the same time has sufficient formality to be systematically transformed into instructions to test that an implementation of the system complies with the specified requirements. The method further provides support for transforming the requirements into a test description suitable for verifying that the system complies with the specified requirements. As a result, even persons inexperienced in requirements capture and test instruction can be productive with these tasks. The quality of requirements specifications will also be improved since they will have a predictable form and can be checked for errors and incompleteness.

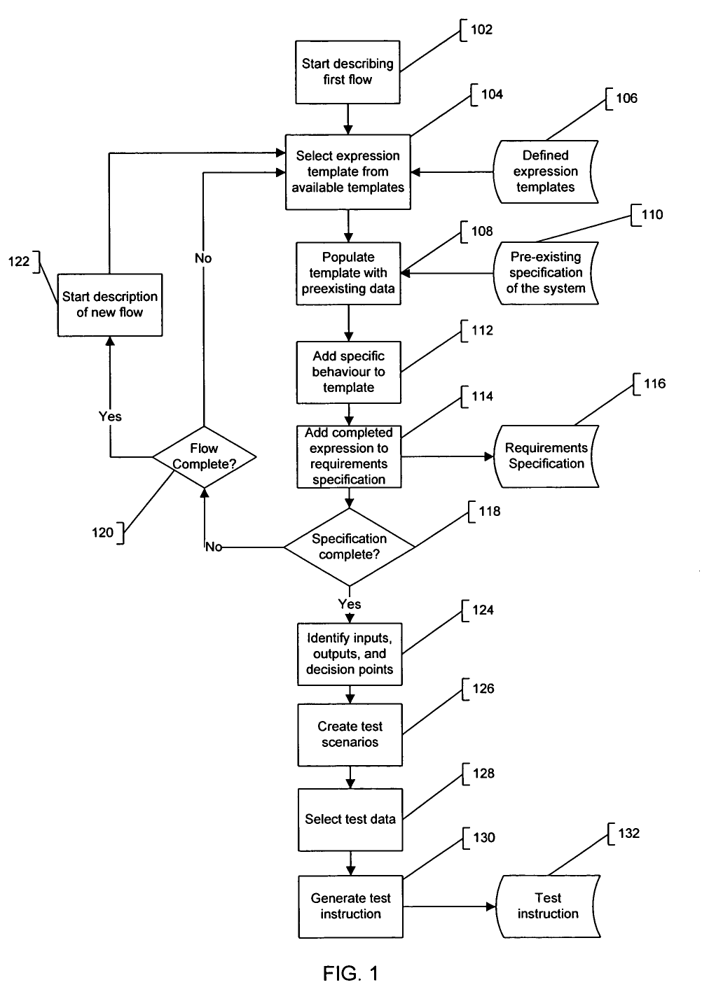

Referring now to FIG. 1, there is shown a process flow diagram which depicts a method 100 for capturing requirements on a system and subsequently transforming them into a test instruction for the system, in accordance with an embodiment of the invention. Method 100 begins at block 102.

The requirements specification created by an embodiment of the invention may be structured into a set of flows, whereas each flow captures a well defined sequence of events specifying requirements on how the system should interact with its environment and carry out its externally observable behavior. At block 102 a first such flow is created to capture a primary behavior of the system.

At block 104 a selection is made from a defined set of templates (106) that are useful for expressing requirements on a system. Different templates are for expressing different aspects of system requirements in natural language. Each template is typically a few sentences long and consists of fixed text, text fields to be adapted to the specific system, fields that are populated from any pre-existing specifications, and annotations used to identify aspects of the requirements that can be used to derive a test instruction for the system. Typically, but not limited to, templates for describing the following are available to choose from: input to the system, output from the system, business logic, data management, conditional and/or repeated behaviors.

When a template has been selected, method 100 proceeds to block 108 where the template is populated with information from a pre-existing specification of the system (110) if available. Examples of such specifications include high-level descriptions of the categories of users that are to use the system and high level definitions of the tasks that these user categories should be able to carry out with the system. One form for such information is a use-case model expressed with the Unified Modeling Language (UML).

Proceeding now to block 112, the template is completed by replacing place-holder text in the template with a description of behavior that is specific to the system. This information is typically gathered from the customers of the system and captured by a system analyst responsible for defining requirements.

Proceeding now to block 114, the description of the system behavior corresponding to the template selected in block 104 is added to the requirements specification (116) in the flow that currently is being specified.

Proceeding now to block 118, a decision is made as to if the specification is complete. If the specification is complete, this method 100 continues at block 124. If the specification is not complete this method 100 continues at block 120.

At block 120, a decision is made as to if the behavior that remains to be specified for the system is to be included in the flow currently being specified or if it should be captured in a separate flow. In the first case, this method 100 continues at block 104. In the second case, this method 100 continues at block 122.

At block 122, a new flow is created which will be used to capture the remaining behavior to be specified for the system. This method 100 then continues at block 104.

When moving from block 118 to block 124 a set of completely specified flows capturing the requirements on the system is available. These flows will now, by the following steps of this method 100, be transformed into an instruction for verifying that any implementation of the system complies with the specified requirements.

At block 124 the flows are inspected to identify points of input to the system, points of outputs from the system, and decision points which effect any particular execution of the flows. These are identified based on predefined annotations present in the templates that have repeatedly, in block 104, been combined into the present set of flows.

At block 126 concrete test scenarios are created by combining the present set of flows in various combinations. For each test scenario it is then specified for the identified inputs which different classes of values are applicable such as Valid, Invalid, Upper bound, Lower bound, or, Not Applicable, and where the identified conditions take on different values. Each such combination of values and flows forms one test case. The sum of all test cases will form a comprehensive test of that any implementation of the system complies with the requirements of the system as specified.

At block 128 the concrete values that should be used for the different inputs to the system are defined.

At block 130 a test instruction (132) is generated on a form that either is suitable for machine processing or as an instruction to a human tester. The instruction will capture the test cases to be carried out, what the different steps of these test cases are, what input data that should be used and what output data that should be verified.

Through the use of the above method embodiment, it will be appreciated that by employing the different steps of the embodiment, the result is a requirements specification that has a well-defined form while still being expressed in natural language. Also the embodiment will enable transformation of requirements into a test instruction based on the captured requirements. The ultimate result is that both requirements specifications and test instructions are easier to create, even for less technical users. The form of the specifications makes them easy to read and understand while still carrying the rigor and formality necessary to ensure accurate specification of requirements and systematic testing of any implementations for compliance with these requirements.

The present invention can include embodiments in the form of computer-implemented processes and apparatuses for carrying out those processes. The invention can also include embodiments in the form of computer program code containing instructions embodied in a tangible media such as CD-ROM's, hard-drives, or any other computer readable storage medium, or where the computer code is loaded and/or executed by a computer, or where the computer code is transmitted over some transmission mechanism such as electrical wiring, fiber optics, or electromagnetic radiation, wherein, when the computer program code is loaded onto and executed by a computer, the computer becomes an apparatus for practicing the invention.

While the invention has been described with reference to a preferred embodiment, it will be understood by those skilled in the art that various changes may be made and equivalents may be substituted for elements thereof without departing from the scope of the invention. In addition, modifications may be made to adapt a particular situation to the teachings of the invention without departing from the essential scope of it. Therefore, it is intended that the invention not be limited to the particular embodiment disclosed as the best mode contemplated for carrying out this invention, but the invention will include all embodiments falling within the scope of the appended claims.

What is claimed as the invention is:

1. A method for capturing requirements on a system and transforming said requirements into test instructions for the system, the method comprising: Specifying requirements by creating sequences of natural language sentences derived from a set of configurable templates and preexisting formalized knowledge about the systems users and the structure of the possible uses of the system and then transforming the captured requirements into a set of test instructions for the system.

2. The method of claim 1, wherein: the system is a digital processing system, or part thereof, comprising a combination of the following: commercially available software, custom built software, commercially available hardware, custom built hardware.

3. The method of claim 1, wherein: the system is a business or enterprise seen as a set of business processes that communicates with their environment.

4. The method of claim 1, wherein: the requirements on the system are captured as a set of flows describing various paths or parts of paths through the system.

5. The method of claim 1, wherein: templates for valid sentences are adapted to take into account any pre-existing description of the system.

6. The method of claim 5, wherein: the pre-existing description of the system is on the form of a Unified Modeling Language use-case model.

7. The method of claim 1, wherein: the application of a template results in annotations of the resulting requirements specification.

8. The method of claim 7, wherein: the annotations are used to transform the requirements specification into a test instruction.

9. The method of claim 8, wherein: the annotations are used to identify points in an execution of the system, for the purpose of testing, where data is input to or output from the system or where the continuation of the execution depends on conditions internal or external to the system.

10. The method of claim 9, wherein: the input test data needed at the data input points are categorized into the following categories: valid, invalid, upper bound, lower bound, or not applicable.

11. The method of claim 9, wherein: it is identified what the concrete values to be provided at input data points and what the concrete values to be expected at output data points should be.

12. The method of claim 4, wherein: the structure of a test instruction is determined by creating combinations of flows that form concrete test scenarios.

13. The method of claim 12, wherein: the application of a template results in annotations of the resulting requirements specification.

14. The method of claim 13, wherein: the annotations are used to transform the requirements specification into a test instruction.

15. The method of claim 14, wherein: the annotations are used to identify points in an execution of the system, for the purpose of testing, where data is input to or output from the system or where the continuation of the execution depends on conditions internal or external to the system.

16. The method of claim 15, wherein: the input test data needed at the data input points are categorized into the following categories: valid, invalid, upper bound, lower bound, or not applicable.

17. The method of claim 15, wherein: it is identified what the concrete values to be provided at input data points and what the concrete values to be expected at output data points should be for each combination of flows.

18. The method of claim 1, wherein: a complete test instruction suitable for machine processing or for carrying out a manual test procedure is generated.

19. A storage medium encoded with a machine readable computer program code for capturing requirements on a system and transforming said requirements into test instructions for the system, the storage medium including instructions causing a computer to implement a method, the method comprising: Specifying requirements by creating sequences of natural language sentences derived from a set of configurable templates and preexisting formalized knowledge about the systems users and the structure of the possible uses of the system and then transforming the captured requirements into a set of test instructions for the system.

20. The storage medium of claim 19, wherein: the system is a digital processing system, or part thereof, comprising a combination of the following: commercially available software, custom built software, commercially available hardware, custom built hardware.

21. The storage medium of claim 19, wherein: the system is a business or enterprise seen as a set of business processes that communicates with their environment.

22. The storage medium of claim 19, wherein: the requirements on the system are captured as a set of flows describing various paths or parts of paths through the system.

23. The storage medium of claim 19, wherein: templates for valid sentences are adapted to take into account any pre-existing description of the system.

24. The storage medium of claim 23, wherein: the pre-existing description of the system is on the form of a Unified Modeling Language use-case model.

25. The storage medium of claim 19, wherein: the application of a template results in annotations of the resulting requirements specification.

26. The storage medium of claim 25, wherein: the annotations are used to transform the requirements specification into a test instruction.

27. The storage medium of claim 26, wherein: the annotations are used to identify points in an execution of the system, for the purpose of testing, where data is input to or output from the system or where the continuation of the execution depends on conditions internal or external to the system.

28. The storage medium of claim 27, wherein: the input test data needed at the data input points are categorized into the following categories: valid, invalid, upper bound, lower bound, or not applicable.

29. The storage medium of claim 27, wherein: it is identified what the concrete values to be provided at input data points and what the concrete values to be expected at output data points should be.

30. The storage medium of claim 22, wherein: the structure of a test instruction is determined by creating combinations of flows that form concrete test scenarios.

31. The storage medium of claim 30, wherein: the application of a template results in annotations of the resulting requirements specification.

32. The storage medium of claim 31, wherein: the annotations are used to transform the requirements specification into a test instruction.

33. The storage medium of claim 32, wherein: the annotations are used to identify points in an execution of the system, for the purpose of testing, where data is input to or output from the system or where the continuation of the execution depends on conditions internal or external to the system.

34. The storage medium of claim 33, wherein: the input test data needed at the data input points are categorized into the following categories: valid, invalid, upper bound, lower bound, or not applicable.

35. The storage medium of claim 33, wherein: it is identified what the concrete values to be provided at input data points and what the concrete values to be expected at output data points should be for each combination of flows.

36. The storage medium of claim 19, wherein: a complete test instruction suitable for machine processing or for carrying out a manual test procedure is generated.

37. A computer digital signal for capturing requirements on a system and transforming said requirements into test instructions, the computer digital signal comprising code configured to cause a processor to implement a method, the method comprising: Specifying requirements by creating sequences of natural language sentences derived from a set of configurable templates and preexisting formalized knowledge about the systems users and the structure of the possible uses of the system and then transforming the captured requirements into a set of test instructions for the system.

38. The computer digital signal of claim 37, wherein: the system is a digital processing system, or part thereof, comprising a combination of the following: commercially available software, custom built software, commercially available hardware, custom built hardware.

39. The computer digital signal of claim 37, wherein: the system is a business or enterprise seen as a set of business processes that communicates with their environment.

40. The computer digital signal of claim 37, wherein: the requirements on the system are captured as a set of flows describing various paths or parts of paths through the system.

41. The computer digital signal of claim 37, wherein: templates for valid sentences are adapted to take into account any pre-existing description of the system.

42. The computer digital signal of claim 41, wherein: the pre-existing description of the system is on the form of a Unified Modeling Language use-case model.

43. The computer digital signal of claim 37, wherein: the application of a template results in annotations of the resulting requirements specification.

44. The computer digital signal of claim 43, wherein: the annotations are used to transform the requirements specification into a test instruction.

45. The computer digital signal of claim 44, wherein: the annotations are used to identify points in an execution of the system, for the purpose of testing, where data is input to or output from the system or where the continuation of the execution depends on conditions internal or external to the system.

46. The computer digital signal of claim 45, wherein: the input test data needed at the data input points are categorized into the following categories: valid, invalid, upper bound, lower bound, or not applicable.

47. The computer digital signal of claim 45, wherein: it is identified what the concrete values to be provided at input data points and what the concrete values to be expected at output data points should be.

48. The computer digital signal of claim 40, wherein: the structure of a test instruction is determined by creating combinations of flows that form concrete test scenarios.

49. The computer digital signal of claim 48, wherein: the application of a template results in annotations of the resulting requirements specification.

50. The computer digital signal of claim 49, wherein: the annotations are used to transform the requirements specification into test instruction.

51. The computer digital signal of claim 50, wherein: the annotations are used to identify points in an execution of the system, for the purpose of testing, where data is input to or output from the system or where the continuation of the execution depends on conditions internal or external to the system.

52. The computer digital signal of claim 51, wherein: the input test data needed at the data input points are categorized into the following categories: valid, invalid, upper bound, lower bound, or not applicable.

53. The computer digital signal of claim 51, wherein: it is identified what the concrete values to be provided at input data points and what the concrete values to be expected at output data points should be for each combination of flows.

54. The computer digital signal of claim 37, wherein: a complete test instruction suitable for machine processing or for carrying out a manual test procedure is generated.
